(19) United States
(12) Patent Application Publication
(10) Pub. No.: US 2026/0127437 A1
(43) Pub. Date: May 7, 2026

(54) METHOD AND APPARATUS FOR DYNAMIC DETERMINATION OF DATA COMPRESSION AND DECOMPRESSION METHOD IN NEURAL NETWORK MODEL

(71) Applicant: SAMSUNG ELECTRONICS CO., LTD., Suwon-si (KR)

(72) Inventors: Suji KIM, Suwon-si (KR); Hyoa KANG, Suwon-si (KR); Sung Kwang CHO, Suwon-si (KR); Hee Min CHOI, Suwon-si (KR); Dokwan OH, Suwon-si (KR)

(73) Assignee: SAMSUNG ELECTRONICS CO., LTD., Suwon-si (KR)

(21) Appl. No.: 19/194,859

(22) Filed: Apr. 30, 2025

(30) Foreign Application Priority Data
Nov. 6, 2024 (KR) 10-2024-0156300

(51) Int. Cl. G06N 3/082

(52) U.S. Cl. CPC G06N 3/082

(57) ABSTRACT

A method and apparatus for a dynamic determination of a data compression and decompression method in a neural network model are provided. The apparatus for a dynamic determination of a data compression method computes an importance value based on input data and information related to the input data, determines, based on the importance value, whether to perform lossy compression or lossless compression on the input data, and performs, using the compression parameter, the lossy compression or the lossless compression on the input data, based on a result of the determination. In addition, the apparatus for a dynamic determination of a data decompression method decompresses data that is compressed by the apparatus for a dynamic determination of a data compression method.

### CROSS-REFERENCE TO RELATED APPLICATION

This application claims priority from Korean Patent Application No. 10-2024-0156300, filed on Nov. 6, 2024, in the Korean Intellectual Property Office, the entire disclosure of which is incorporated herein by reference for all purposes.

### BACKGROUND

### 1. Field

Methods and apparatuses consistent with embodiments relate to a method and apparatus for a dynamic determination of a data compression and decompression method in a neural network model.

### 2. Description of the Related Art

In recent years, artificial neural networks based on the Transformer structure have become the dominant structure for large-scale generative models in various domains such as language, vision, and multimodal processing. Transformer models have the power to process large amounts of data and provide advanced prediction and generation capabilities, but they require large amounts of hardware resources to implement. To effectively utilize limited hardware resources, efficient data compression and decompression techniques are essential.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of an embodiment, there is provided a method for a dynamic determination of a data compression method in a neural network model, the method including computing an importance value based on input data and information related to the input data, determining, based on the importance value, whether to perform lossy compression or lossless compression on the input data, and performing, using a compression parameter, the lossy compression or the lossless compression on the input data, based on a result of the determination.

The compression parameter may include a first compression parameter corresponding to the lossy compression or a second compression parameter corresponding to the lossless compression, generated based on the importance value, and the performing of lossy compression or lossless compression may include performing lossy compression using the first compression parameter and performing lossless compression using the second compression parameter.

The compression parameter may include a predetermined third compression parameter corresponding to the lossy compression or a predetermined fourth compression parameter corresponding to the lossless compression parameter, and the performing of lossy compression or lossless compression may include performing lossy compression using the third compression parameter and performing lossless compression using the fourth compression parameter.

The computing of an importance value may include deriving the importance value based on at least one of information on a layer block that outputs the input data or information on the neural network model.

The computing of an importance value may be performed by a first neural network model, wherein the first neural network model may be trained based on a plurality of pieces of data obtained through the neural network model and an importance value corresponding to each of the plurality of pieces of data.

The performing of lossy compression may be performed by a second neural network model, the performing of lossless compression may be performed by a third neural network model, and the second neural network model and the third neural network model may be trained using an objective function that reduces a data rate of the input data.

The neural network model may be configured to perform, based on a training result of at least one of the first neural network model, the second neural network model, or the third neural network model, at least one of updating a parameter value of the neural network model or changing a structure of the neural network model.

The changing of the structure of the neural network model may include at least one of pruning a layer block of low importance among a plurality of layer blocks of the neural network model or changing a channel of the neural network model for the layer block of the low importance. The layer block of the low importance has a lowest importance among the plurality of layer blocks or has an importance below a predetermined threshold.

The neural network model may include a plurality of layer blocks, and each of at least some of the plurality of layer blocks may be configured to transfer data that is output from a corresponding layer block to a next layer block, based on predetermined information.

The neural network model may include a plurality of layer blocks, the computing of an importance value may include, computing the importance value based on data that is output from a corresponding layer block, among the plurality of layer blocks, and information on the output data, and the determining of whether to perform lossy compression or lossless compression on the input data may further include transmitting, among the plurality of layer blocks, the output data to a next layer block, based on the importance value of the corresponding layer block.

The determining of whether to perform lossy compression or lossless compression on the input data may include determining whether to perform lossy compression or lossless compression based on the importance value and hardware resources.

According to another aspect of an embodiment, there is provided a method for a dynamic determination of a data decompression method in a neural network model, the method including determining, based on input compressed data and a compression parameter, whether lossy compression or lossless compression has been performed on the input compressed data and, in response to a result of the determination, performing, using the compression parameter, lossy decompression or lossless decompression on the input compressed data to obtain decompressed data.

The performing of lossy decompression may be performed by a second neural network model, the performing of lossless decompression may be performed by a third neural network model, and the second neural network model may be trained using an objective function that reduces a difference (Distortion) between the decompressed data and original data.

According to another aspect of an embodiment, there is provided an apparatus for a dynamic determination of a data compression method in a neural network model, the apparatus including at least one memory configured to store compressed input data and a compression parameter, at least one processor connected to the at least one memory and configured to execute a computer-readable program included in the at least one memory, to derive an importance value based on input data and information related to the input data, determine, based on the importance value, whether to perform lossy compression or lossless compression on the input data, and perform, using a compression parameter, lossy compression or lossless compression on the input data, based on a result of the determination.

The at least one processor may be configured to select, based on the importance value, a compression method from among a plurality of compression methods for performing lossy compression or lossless compression.

The at least one memory may include at least one main memory and at least one cache memory, the at least one processor may be executed using the at least one cache memory, and the input data and the compression parameter may be stored in the at least one main memory.

According to another aspect of an embodiment, there is provided an apparatus for a dynamic determination of a data decompression method in a neural network model, the apparatus including at least one memory configured to store compressed data and a compression parameter, at least one processor connected to the at least one memory and configured to execute a computer-readable program included in the at least one memory, to determine, based on the compressed data and the compression parameter, whether lossy compression or lossless compression has been performed on the compressed data, and perform, using the compression parameter, lossy decompression or lossless decompression on the compressed data, in response to a result of the determination.

The at least one memory may include at least one main memory and at least one cache memory, the at least one processor may be executed using the at least one cache memory, and the compressed data and the compression parameter may be stored in the at least one main memory.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a flowchart schematically illustrating a method for a dynamic determination of a data compression and decompression method, according to an embodiment;

FIG. 2 is a diagram illustrating an encoding module for a dynamic determination of a data compression method, according to an embodiment;

FIG. 3 is a diagram illustrating a decoding module for a dynamic determination of a data decompression method, according to an embodiment;

FIGS. 4A, 4B, and 4C are diagrams illustrating a training process for a method for a dynamic determination of a data compression and decompression method, according to an embodiment;

FIG. 5A and FIG. 5B are block diagrams illustrating a dynamic determination of a data compression and decompression method, according to an embodiment;

FIG. 6 is a flowchart of a method for a dynamic determination of a data compression and decompression method, according to an embodiment;

FIG. 7 is a block diagram illustrating a data processing device according to an embodiment; and

FIG. 8 is a block diagram of an apparatus for performing a method for a dynamic determination of a data compression and decompression method, according to an embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

A neural network model may have a structure including a plurality of layers, and each of the layers may process input data and, based on a processing result, generate output data to be transferred to a next layer. A neural network model may include an input layer, an intermediate layer (or a hidden layer), and an output layer, and each layer may perform various operations depending on a purpose of a neural network.

The input data may be computed based on a weight and a bias at each layer, and the model may progressively abstract and learn the data in a computing process. A number and a configuration of the layers may vary depending on a type and a purpose of a particular neural network, and the layers may perform a variety of functions. Furthermore, each layer may necessarily include one or more neurons, and learning may be performed through a connection between neurons.

Neural network models used in the following embodiments may encompass any form of neural network structure that may include a plurality of layers and are not limited to a particular number of layers, a manner of configuration, or a computation method of each layer.

In the following embodiments, operations of each module may be performed sequentially, but not necessarily. For example, an order of the operations of each module may be changed, and at least two modules may be performed in parallel. In addition, for ease of description, the modules are described separately from each other, but each module may be understood as a logically distinct concept from each other. Each module may be implemented on one or more hardware devices, according to the hardware design, and may communicate with each other in a suitable manner depending on the implementation form.

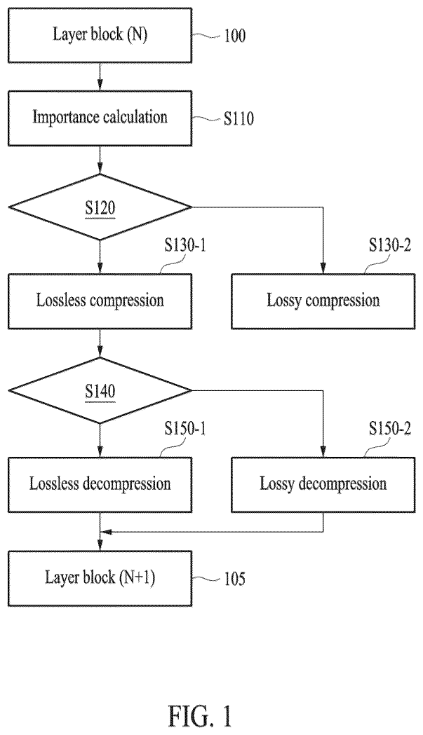

FIG. 1 is a flowchart schematically illustrating a method for a dynamic determination of a data compression and decompression method, according to an embodiment.

The method for a dynamic determination of a data compression and decompression method (hereinafter, referred to as “the determining method”) may be performed by a data processing device. The data processing device may include at least one processor. According to an embodiment, the data processing device may be implemented as a combination of a plurality of computing modules communicating with each other, including an encoding module and a decoding module.

In the following embodiments, operations may be performed sequentially, but not necessarily. For example, an order of the operations may be changed, and at least two operations may be performed in parallel.

The data processing device according to an embodiment may compress and decompress data of a neural network model by dynamically selecting lossy or lossless compression according to importance by performing operations S110 to S160-2. Operations S110 to S160-2 may be applied iteratively or selectively to all layers or layer blocks in the neural network model.

In operation S110, the data processing device may derive an importance value by calculating the importance of input data from the input data and related information obtained from an N-th layer block 100. A layer block may include one or more layers that form a neural network, such as fully connected layers, convolutional layers, batch normalization layers, and activation layers. For example, a layer block may be a transformer block including self-attention layers, normalization layers, and feedforward layers; a residual block including convolutional layers, batch normalization, and skip connections; and an inverted residual block including convolutional layers and shortcut connections.

In operation S120, the data processing device may determine whether to perform lossy compression or lossless compression of data based on the importance value derived in operation S110.

In operations S130-1 and S130-2, the data processing device may perform lossless compression S130-1 or lossy compression S130-2 based on a result of the determination in operation S120.

In operation S140, the data processing device may distinguish between lossy decompression and lossless decompression based on the manner of compression performed in operation S130-1 or operation 130-2.

The data processing device may perform lossless decompression S150-1 or lossy decompression S150-2 according to the result of the distinguishing in operation S140 to transfer the restored data to the target layer block, the N+1st layer block 105.

Operations S110 to S150-2 may be applied iteratively or selectively to all layers or layer blocks in the neural network model.

The data processing device may apply compression to attention data and attention activation data generated in the neural network model (or, a deep learning model), such that when compressed data is decompressed, a result may be obtained as similar as possible to the data to which compression is not applied, and the data may be represented in fewer bits, thereby increasing efficiency of compression and decompression. The data processing device may consider characteristics of the data to maintain high compression efficiency and reduce loss of important data.

By efficiently reducing a transmission size of the data through the determination method, the data processing device may process a larger amount of data in a limited bandwidth and accelerate data transmission without degrading the performance of the existing model, thereby increasing inference speed and learning speed. Furthermore, through the determination method, the data processing device may reduce bandwidth power consumption and improve power efficiency by reducing an amount of communication between memories or between integrated circuits within a system on chip (SoC) and may resolve power consumption and heat generation issues by reducing memory input/output (I/O).

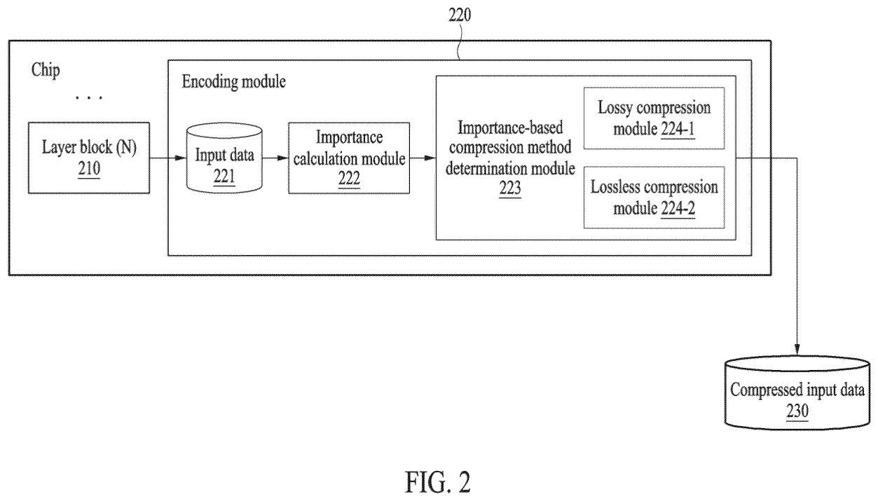

FIG. 2 is a diagram illustrating an encoding module 220 for a dynamic determination of a data compression method, according to an embodiment.

The description with reference to FIG. 1 may apply to FIG. 2, and a repeated description may be omitted.

The encoding module 220 may include an importance calculation module 222, an importance-based compression method determination module 223, a lossy compression module 224-1, and a lossless compression module 224-2. According to an embodiment, the encoding module 220 may include at least one memory within the encoding module 220 in order to perform operations of each module and may also use at least one memory external to the encoding module 220.

The importance calculation module 222 may derive an importance value based on input data 221 and information related to the input data 221.

The input data 221 of the importance calculation module 222 may refer to result data from each layer block of a neural network model. For example, the input data 221 may refer to various forms of data that may be output from a layer, such as a feature map, an intermediate representation, a probability distribution, an attention map, a loss value, a gradient, and the like. In addition, the input data 221 may refer to attention activation data from an inference phase of the neural network model having a transformer-based structure (e.g., a transformer neural network including an encoder and a decoder, with an attention mechanism). The information related to the input data 221 may refer to at least one of information of a layer block that has output the input data 221 or information of the neural network model.

The input data 221 may be in the form of a vector having a multi-dimensional matrix structure. The input data 221 may include data of various data formats, such as real number, integer, and established data formats. The input data 221 may also include data in size units of 32/16/8/4/2 bits. The encoding module 220 may flexibly use data of various data formats and may thus be utilized when various quantized data formats are used considering hardware resources. The input data 221 may correspond to a result of compression processing in a previous layer block. According to an embodiment, the encoding module 220 may obtain the input data 221 separately stored in a memory or may receive the input data 221 from a previous layer block that is performed in real time.

A layer block 210 that outputs the input data 221 may refer to a structure that performs an operation for outputting the input data 221. The layer block 210 may include a block-wise layer composed of N (N≥1) layers of the neural network model and operation algorithms thereof. According to an embodiment, the layer block 210 may refer to a transformer block, and the layer block 210 may output an attention activation value. The importance value (Imp) (Imp∈R^{N} (N≥1)) may be expressed in the form of a multi-dimensional vector. The multi-dimensional vector is a set of numerical values having multiple dimensions and may include multiple elements or characteristics. The importance value may be derived through a method of evaluating importance of each layer block of the neural network model. The method of evaluating the importance may be applied to various models and may include all methods that may be used to quantitatively analyze an impact on performance of a model. The importance calculation module 222 may include, for example, a method of measuring performance of a model by using a performance evaluation index such as perplexity, after removing a layer block, and comparing the performance with that of an original model, a validation loss method, which determines that a layer block has high importance when a loss increases significantly after the layer block is removed, a method that determines importance by measuring a cosine distance between an input layer and an output layer of a layer block, a method that determines importance by measuring a change in performance in a downstream task, a method that determines importance based on an effect of removing a layer block on image quality by utilizing a Fréchet inception distance (FID), and a method that determines importance by evaluating an effect of a layer block on output data by measuring a change in output features. For example, an importance determination module executed in a diffusion model may calculate an importance value of a layer block by utilizing a layer index or a step index.

The importance-based compression method determination module 223 may determine, based on the importance value, whether to perform lossy compression or lossless compression on the input data 221.

Lossy compression may be a compression method that reduces a file size while allowing a loss of some information in original data during a process of compressing the data, such that decompressed data after compression may maintain an acceptable quality level, though not identical to the original. Lossy compression may reduce the file size by allowing a loss in unnecessary or less important portion of data, and a higher compression rate may result in more data loss.

Lossless compression may be a compression method that reduces the file size while maintaining the original data intact so that no information may be lost during the process of compressing the data. When decompressing compressed data, lossless compression may decompress the compressed data in exactly the same form as the original data.

In general, lossy compression, though resulting in different data from the original upon decompression, may be represented in fewer bits compared to lossless compression and may thus have higher compression efficiency than lossless compression. Lossless compression may result in data identical to the original data when decompressed, but may have a relatively low compression efficiency compared to lossy compression.

When lossless compression with low compression efficiency is used, the neural network model may obtain a result with the same operation efficiency as when compression is not used. In addition, when lossy compression with a high loss rate is used, the neural network model may obtain a result different from the original data, and since the result may be different, the performance of the neural network model may decrease.

The importance-based compression method determination module 223 may dynamically select and perform lossy and lossless compression based on importance to increase operation efficiency and allow important data to be maintained, thereby ensuring the performance of the neural network model.

The importance-based compression method determination module 223 may be implemented using a neural network model that infers whether to perform lossy compression or lossless compression on the input data 221 based on importance. In addition, according to an embodiment, the importance-based compression method determination module 223 may be implemented as a model having a basic operation structure. The importance-based compression method determination module 223 that is implemented using a rule-based learning model among neural network models may determine whether to perform lossy compression or lossless compression on the input data 221, based on a predetermined threshold.

A higher importance value may indicate that the layer block has a significant influence on the performance of the neural network model. The importance-based compression method determination module 223 may determine lossy compression of the input data 221 when the importance value is less than or equal to a predetermined threshold, and may determine lossless compression of the input data 221 when the importance value is greater than or equal to the predetermined threshold.

According to an embodiment, the predetermined threshold may be variously set based on a hardware device on which the neural network model is executed, characteristics of the neural network model, characteristics of the layer block 210 from which the input data 221 is output, characteristics of the input data 221, and the like. In a case of the importance-based compression method determination module 223 that is implemented using a learnable neural network model, the predetermined threshold may be dynamically set while evaluating the characteristics and compression performance of the input data 221 during a learning process of the neural network model.

According to an embodiment, when the importance-based compression method determination module 223 determines, based on the importance value, to perform lossy compression of the input data 221, the importance-based compression method determination module 223 may generate a first compression parameter corresponding to the lossy compression. The first compression parameter may include elements that determine how much loss is to be allowed when compressing data and may be used to adjust a trade-off between data quality and the compression rate.

According to an embodiment, when the importance-based compression method determination module 223 determines, based on the importance value, to perform lossless compression of the input data 221, the importance-based compression method determination module 223 may generate a second compression parameter corresponding to the lossless compression. The second compression parameter may include elements that may optimize a data structure and efficiency in order to preserve the input data 221 in an original form thereof as much as possible.

In response to the determination of the importance-based compression method determination module 223, the lossy compression module 224-1 may use compression parameters to perform lossy compression of the input data 221, and the lossless compression module 224-2 may use the compression parameters to perform lossless compression of the input data 221.

A lossy compression module and a lossless compression module may be implemented using a trainable neural network model. According to an embodiment, the lossy compression module and the lossless compression module may be implemented as a model having a basic operation structure. The lossy compression module and the lossless compression module may perform an operation algorithm and a compression algorithm. The compression algorithm may include, for example, compression algorithms such as a Huffman coding and Lempel-Ziv-Welch (LZW) algorithm.

The lossy compression module and the lossless compression module may each perform compression using compression parameters generated by the importance-based compression method determination module 223 and corresponding to each of the lossy compression module and the lossless compression module. Alternatively, the lossy compression module and the lossless compression module may each perform compression using compression parameters that have been predetermined by each of the lossy compression module and the lossless compression module.

According to an embodiment, the lossy compression module and the lossless compression module may each include one or more compression modules. Different compression modules may be represented by different compression methods, algorithms, or neural networks. Each compression module may be configured differently depending on data type, algorithm selection, compression target, hardware resources, and the like. The importance-based compression method determination module 223 may select a performing compression module from among at least one compression module based on an importance value. For example, when the importance value is high compared to data of other layer blocks, a lossless compression module that minimizes data loss may be selected as the performing compression module from among lossless compression modules. The lossy compression module and the lossless compression module may perform lossy compression or lossless compression using the selected performing compression module.

The encoding module 220 may store compressed input data 230, which is compressed by lossy compression or lossless compression, and compression parameters. The compressed input data 230 compressed by each of the lossy compression module and the lossless compression module may have a less information amount than the input data 221 and may be represented in fewer bits than the input data 221. The compressed input data 230 may be data in the form of a bit rate or a vector value having a multi-dimensional matrix structure. Since compression parameters used for compression may be used during decompression, the encoding module 220 may store the compression parameters.

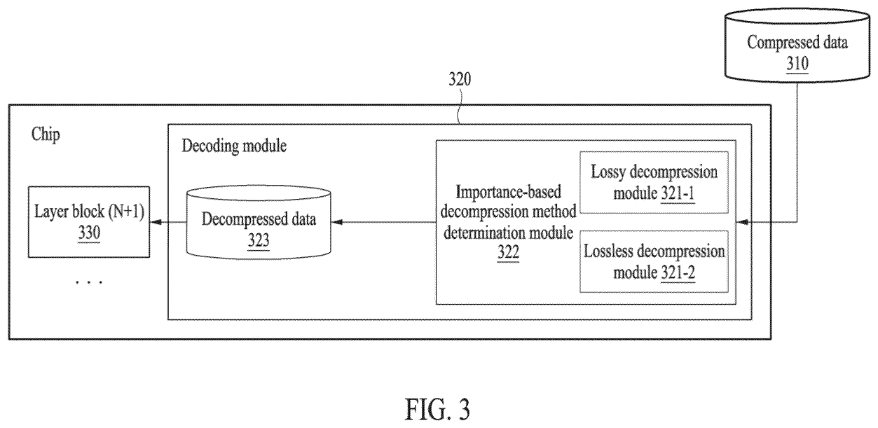

FIG. 3 is a diagram illustrating a decoding module for a dynamic determination of a data decompression method, according to an embodiment.

The description with reference to FIGS. 1 and 2 may apply to FIG. 3, and a repeated description may be omitted.

A decoding module 320 may include an importance-based decompression method determination module 322, a lossy decompression module 321-1, and a lossless decompression module 321-2. According to an embodiment, the decoding module 320 may include at least one memory within the decoding module 320 in order to perform operations of each module and may also use at least one memory external to the decoding module 320.

Input compressed data 310 and compression parameters may be stored in the at least one memory. The decoding module 320 may load the compression parameters and the input compressed data 310, which are being stored. In addition, the decoding module 320 may directly receive the input compressed data 310 and the compression parameters generated by an encoding module and load the input compressed data 310 and the compression parameters to the decoding module 320.

The importance-based decompression method determination module 322 may determine, based on the input compressed data 310 and the compression parameters, whether lossy compression or lossless compression has been performed.

In response to a determination result of the importance-based decompression method determination module 322, the lossy decompression module 321-1 may perform lossy decompression on the compressed data 310, and the lossless decompression module 321-2 may perform lossless decompression on the compressed data 310. By performing lossy decompression or lossless decompression on the compressed data 310, the lossy decompression module 321-1 and the lossless decompression module 321-2 may obtain decompressed data 323 corresponding to input data of the encoding module.

The compression parameters used in the decompression of the compressed data 310 may include a first compression parameter generated in response to lossy compression or a second compression parameter generated in response to lossless compression, based on an importance value.

The lossy decompression module 321-1 and the lossless decompression module 321-2 may be implemented using a neural network model. In addition, according to an embodiment, the lossy decompression module 321-1 and the lossless decompression module 321-2 may be implemented as a model having a basic operation structure. The lossy decompression module 321-1 and the lossless decompression module 321-2 may perform an operation algorithm and a decompression algorithm. The decompression algorithm may include, for example, a decompression algorithm such as a Huffman decoding LZW decompression algorithm.

According to an embodiment, the lossy decompression module 321-1 and the lossless decompression module 321-2 may each include at least one decompression module. Each decompression module may be configured differently depending on data type, algorithm selection, compression target, hardware resources, and the like.

The importance-based decompression method determination module 322 may select a performing decompression module from among at least one decompression module based on an importance value. For example, when an importance value of the compressed data 310 is high compared to data of other layer blocks, a lossless decompression module that minimizes data loss may be selected as the performing decompression module from among lossless decompression modules. The lossy decompression module and the lossless decompression module may respectively perform lossy decompression and lossless decompression using the selected performing decompression module.

The decompressed data 323 may refer to data in the form of a vector having a same dimension structure as the input data in the encoding module. The decompressed data 323 may have a same data format as the input data in the encoding module. The decompressed data 323 may have a same value as the input data in the encoding module when lossless compression and lossless decompression are performed on the data, but may also have a different value from the input data in the encoding module when lossy compression and lossy decompression are performed on the data.

The decompressed data 323 may be transferred to a next layer block 330 of the layer block 210 that has output the input data of the encoding module 220.

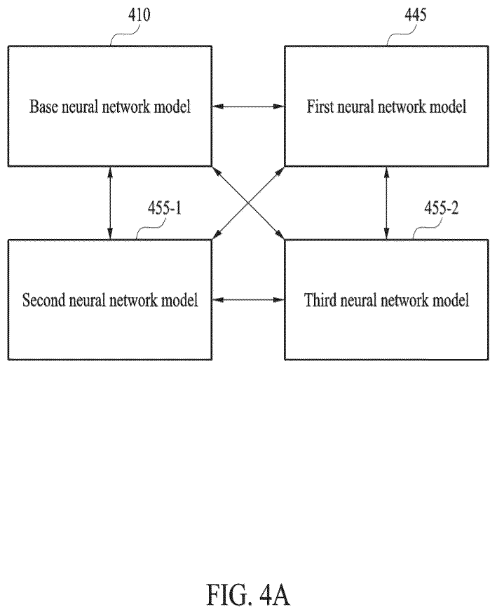

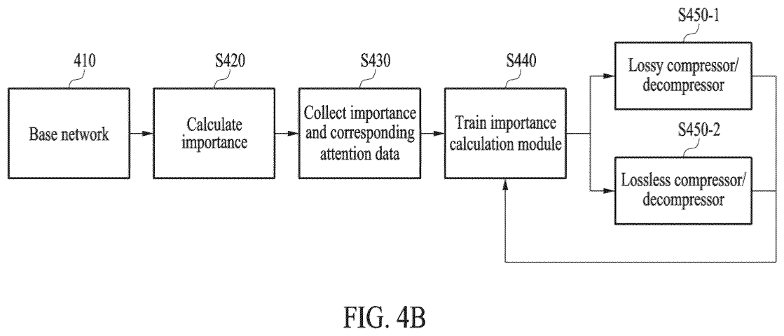

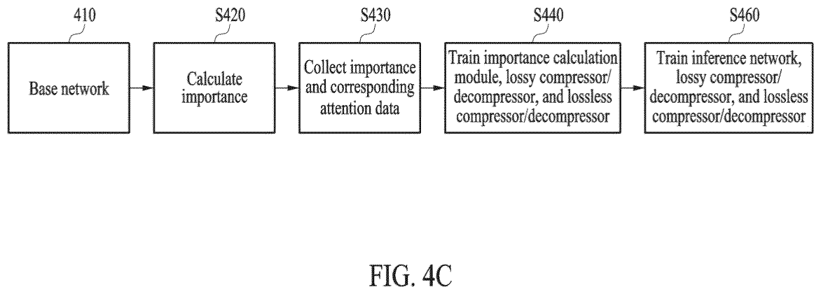

FIGS. 4A to 4C are diagrams illustrating a training process for a method for a dynamic determination of a data compression and decompression method, according to an embodiment.

The description with reference to FIGS. 1 to 3 may apply to FIGS. 4A to 4C, and a repeated description may be omitted.

In the following embodiments, operations may be performed sequentially, but not necessarily. For example, an order of the operations may be changed, and at least two operations may be performed in parallel.

Referring to FIG. 4A, a data processing device may be implemented including a base neural network model 410, a first neural network model 445, a second neural network model 455-1, and a third neural network model 455-2.

The base neural network model 410 may refer to a core network that is responsible for a most basic input and output when multiple networks are combined in a neural network model to perform a task. The first neural network model 445 may implement an importance-based compression method determination module of the data processing device. The second neural network model 455-1 may be used for training and inference of a lossy compression module and a lossy decompression module of the data processing device. The third neural network model 455-2 may be used for training and inference of a lossless compression module and a lossless decompression module of the data processing device.

The data processing device may perform a training process of a method for a dynamic determination of a data compression and decompression method through operations S420 to S450 of FIG. 4B.

In operation S420, the data processing device may perform inference based on the base neural network model 410 as a base network to calculate importance.

In operation S430, the data processing device may calculate and collect data and an importance value corresponding thereto for each layer block.

In operation S440, the first neural network model 445 may be trained based on the data obtained in operation S430 and the importance value corresponding thereto. In addition, the first neural network model 445 may be trained by utilizing a result value through performing operation S450-1 and operation S450-2. For example, the data processing device may obtain an FID value through performing operation S450-1 and operation S450-2, and the first neural network model 445 may be trained to decrease the obtained FID value.

After performing operation S440, the second neural network model 455-1 may be trained in operation S450-1.

After performing operation S440, the third neural network model 455-2 may be trained in operation S450-2. Here, the training of the second neural network model 455-1 (in operation S450-1) may be performed independently from the training of the third neural network model 455-2 (in operation S450-2).

In the training of the second neural network model 455-1, training may be performed using an objective function that reduces an amount of information (Rate) of compressed data and a difference (Distortion) between data decompressed after compression and original data. The third neural network model 455-2 may be trained using the objective function that reduces the amount of information (Rate) of the compressed data.

Operation S420 through operation S450-2 of FIG. 4B may refer to a training process that further includes operation S460 of training the base neural network model 410 in addition to the training process of FIG. 4A.

In operation S460, the base neural network model 410 may be updated based on a training result of at least one of the first neural network model 445 of the importance-based compression method determination module, the second neural network model 455-1 of the importance-based compression method determination module, or the third neural network model 455-2 of the lossless compression module and the lossless decompression module. The base neural network model 410 may update a parameter value of the base neural network model 410 or change a structure of the base neural network model 410 based on the training result of at least one of the first neural network model 445 to the third neural network model 455-2.

The base neural network model 410 may be trained by considering dependency between different layer blocks. Among a plurality of layer blocks of the neural network model 410, a layer block of low importance may be pruned. The layer block of the low importance may have the lowest importance among the plurality of layer blocks or have an importance below a predetermined threshold. In addition, the base neural network model 410 may change a channel of the base neural network model 410 for the layer block of low importance.

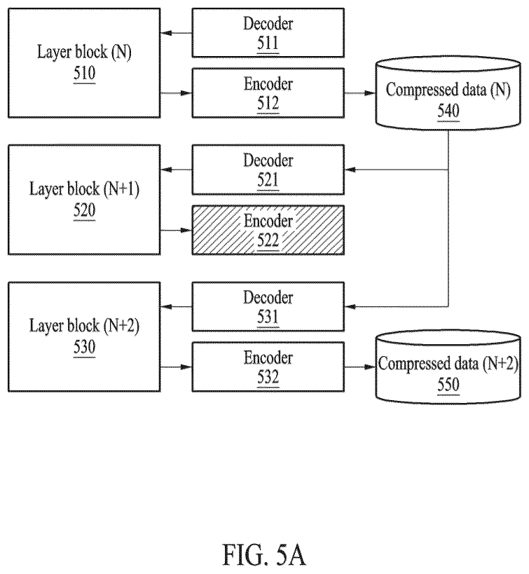

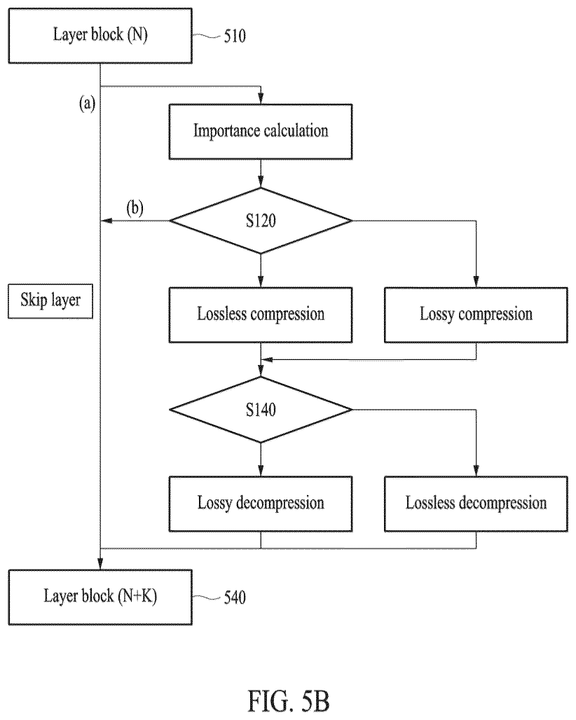

FIG. 5A and FIG. 5B are block diagrams illustrating a dynamic determination of a data compression and decompression method, according to an embodiment.

The description with reference to FIGS. 1 to 4C may apply to FIGS. 5A and 5B, and a repeated description may be omitted.

A neural network model may include a plurality of layer blocks that may each output data, and may not perform data compression and decompression methods on a determined layer block.

Referring to FIG. 5A, the plurality of layer blocks (e.g., a layer block (N) 510, a layer block (N+1) 520, and a layer block (N+2) 530) in the neural network model is illustrated. In the layer block (N+1) 520, an execution of a process in an encoding module 522 may be omitted or stopped, and thus, compressed data (N+1) may not be generated. As the compressed data (N+1) is not generated, the next layer block (N+2) 530 may use previous compressed data (N) 540.

The data processing device may perform operations by omitting layer blocks that consume hardware resources and may thus effectively reduce an amount of information transferred between memories/circuits while maintaining performance of the neural network model, thereby further increasing efficiency of data transmission and reception. In addition, since all samples in a batch performed in a specific layer block may simultaneously skip operations and may efficiently proceed without unnecessary waiting for parallel processing of each sample, an actual improvement in inference speed may be expected.

At least some of the plurality of layer blocks may each transmit, based on predetermined information, data that is output from a corresponding layer block to a next layer block.

Referring to data processing path (a) of FIG. 5B, the data processing device may not perform importance calculation, lossy compression and lossless compression, and lossy decompression and lossless decompression in K layer blocks (skip layers). The data processing device may not perform a data compression and transmission process in a specific layer block (for example, the skip layers of FIG. 5B) according to predetermined information.

The predetermined information may be information provided as input during an inference process of the neural network model. According to an embodiment, the predetermined information may include a layer index that may identify a location of a specific layer in the neural network model, or a timestep index that may indicate a specific execution timepoint in the neural network model. For example, when the neural network model is configured to skip {23rd, 24th, and 25th} layers without calculating importance, the predetermined information may be provided as an input during the inference process as the layer index of {23rd, 24th, and 25th}. In addition, when the neural network model is an image/video generation model having a diffusion-based structure, the neural network model may gradually generate data over timesteps. The neural network model may be configured to skip specific layers without calculating importance at each timestep. For example, the predetermined information may be set to skip {21st, 22nd, 23rd, 24th, and 25th} layers without calculating importance in response to a 10th timestep index, and may be set to skip the {22nd, 23rd, 24th, and 25th} layers without calculating importance in response to the 11th timestep index. Here, the predetermined information may be provided as an input during the inference process of the neural network model in the form of [(timestep index=10, layer index={21, 22,23, 24, 25}), (timestep index=11, layer index={22, 23, 24, 25}) . . . ]. Referring to (b) of FIG. 5B, the importance value may be derived based on data that is output from a corresponding layer block (e.g., the layer block (N) 510) and information related to the output data, in response to each of at least some of the plurality of layer blocks. Based on the importance value of the corresponding layer block, the corresponding output data may be transmitted to the next layer block 540. The data processing device may calculate the importance corresponding to the layer block that is a current target of data processing through an importance calculation module, and according to a result of the importance calculation, may not perform lossy and lossless compression and lossy and lossless decompression on K skip layer blocks. A performance threshold may be set lower than a predetermined threshold, which may be set for determining whether lossy compression is performed. The data processing device may not perform lossy and lossless compression and lossy and lossless decompression when the importance is lower than the performance threshold. The performance threshold may be set lower than the predetermined threshold, which may be set for determining whether lossy compression is performed.

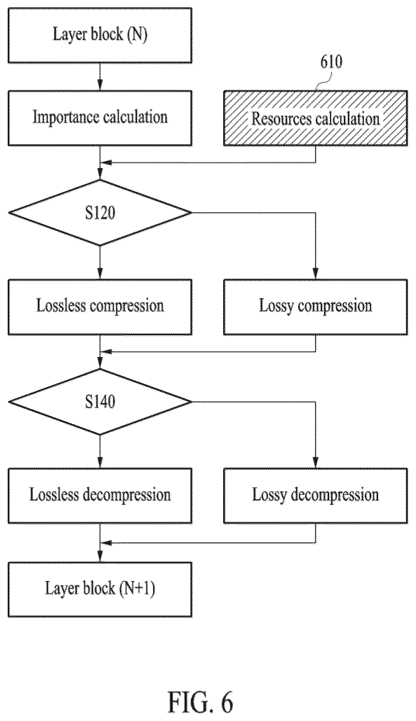

FIG. 6 is a flowchart of a method for a dynamic determination of a data compression and decompression method, according to an embodiment.

The description with reference to FIGS. 1 to 5B may apply to FIG. 6, and a repeated description may be omitted.

The operation of determining whether to perform lossy compression or lossless compression on the input data may determine, based on the importance value and hardware resources calculation 610, whether to perform lossy compression or lossless compression.

The hardware resources may include computation resources, network resources, I/O resources, power, and the like. For example, lossy compression with complex operations may be performed when computation resources are sufficient, and simple lossless compression may be performed when computation resources are insufficient.

In an actual execution environment in which hardware resources are limited, a data processing device may dynamically select an appropriate compression method according to a hardware resources situation that changes due to multiple programs running or increased usage and perform compression and decompression. The data processing device may guarantee stable performance while guaranteeing inference speed in a system in which service time is important.

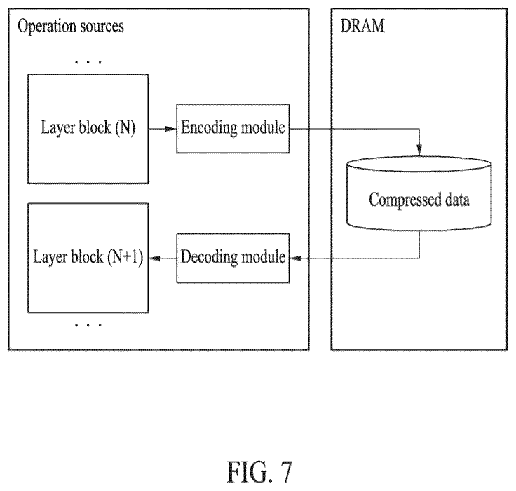

FIG. 7 is a block diagram illustrating a data processing device according to an embodiment.

The description with reference to FIGS. 1 to 6 may apply to FIG. 7, and a repeated description may be omitted.

The data processing device may be executed using at least one memory. The at least one memory may include at least one main memory and at least one cache memory.

The main memory may include a memory capable of storing running programs and data. The main memory may include a memory device that is less expensive than the cache memory and provides a large storage space. For example, the main memory may include dynamic random-access memory (DRAM).

The cache memory may include a memory capable of storing data frequently used by a processor. The cache memory may include a memory device that is faster than the main memory, does not require a refresh, is more expensive than the main memory, and provides a small storage space. For example, the cache memory may include static random-access memory (SRAM).

Referring to FIG. 7, the data processing device may, using a cache memory, perform a method for a dynamic determination of a data compression and decompression method and may transmit a result of the performance to the main memory. Through this, the data processing device may perform a data transaction based on a small amount of information through efficient compression. In addition, the data processing device may quickly transmit data from the cache memory with a small storage space and high cost to the main memory with a large storage space and low cost.

In addition, when compared to an existing calculator having the same cache memory size, the data processing device may process a model with more parameters through faster calculation. Since the data processing device may compress data generated while running a model with a large number of parameters using a high-performance calculator and quickly transmit the compressed data of a small size to the main memory, the data processing device may be less affected by constraints on a cache memory design due to cost.

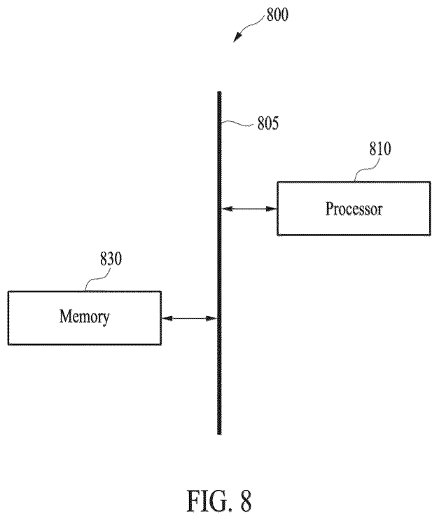

FIG. 8 is a block diagram of an apparatus for performing a method for a dynamic determination of a data compression and decompression method, according to an embodiment.

The description with reference to FIGS. 1 to 7 may apply to FIG. 8, and a repeated description may be omitted.

A processor 810 may derive an importance value based on input data and information related to the input data. The processor 810 may determine, based on the importance value, whether to perform lossy compression or lossless compression on the input data. The processor 810 may perform, using compression parameters, lossy compression or lossless compression on the input data, in response to the determination.

A memory 830 may store various information generated during the processing of the processor 810 described above. In addition, the memory 830 may store various types of data and programs. The memory 830 may include volatile memory or nonvolatile memory. The memory 830 may be equipped with a mass storage medium, such as a hard disk, to store various types of data. According to an embodiment, the memory 830 may include at least one main memory and at least one cache memory. The processor 810 may execute a program and store data using the at least one cache memory. In addition, the processor 810 may transmit a result performed in the at least one cache memory to the at least one main memory.

In addition, the processor 810 may perform at least one method described above with reference to FIGS. 1 to 8 or an algorithm corresponding to the at least one method. The processor 810 may be a data processing device implemented as hardware including a circuit having a physical structure for executing desired operations. For example, the desired operations may include code or instructions included in a program. The processor 810 may be configured as, for example, a central processing unit (CPU), a graphics processing unit (GPU), or a neural network processing unit (NPU). For example, the processor 810 implemented as hardware may include a microprocessor, a CPU, a processor core, a multi-core processor, a multiprocessor, an application-specific integrated circuit (ASIC), and a field programmable gate array (FPGA).

The processor 810 may execute a program and control a data processing device 800. Program code executed by the processor 810 may be stored in the memory 830.

The data processing device 800 may be implemented in the form of an SoC or intellectual property (IP) within the SoC in various types of devices, such as a personal computer (PC), a server device, a mobile device, an embedded device, and the like. For example, the data processing device 800 may be a smartphone, a tablet device, an augmented reality (AR) device, an Internet of things (IoT) device, and/or a medical device that performs voice recognition, image recognition, image classification, and the like using a neural network model, but is not limited thereto. Furthermore, the data processing device 800 may be a dedicated hardware accelerator mounted on the above devices, or a hardware accelerator such as an NPU, a tensor processing unit (TPU), a memory operator, and/or a neural engine, which are dedicated modules for driving a neural network model applied to the devices, but is not limited thereto.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described embodiments, or vice versa.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A method for determining data compression method in a neural network model, the method comprising:
computing an importance value based on input data and information related to the input data;
determining, based on the importance value, whether to perform lossy compression or lossless compression on the input data; and
performing, using a compression parameter, the lossy compression or the lossless compression on the input data, based on a result of the determination.

2. The method of claim 1, wherein the determining of whether to perform the lossy compression or the lossless compression comprises:
determining to perform the lossy compression on the input data based on the importance value being less than a predetermined threshold; and
determining to perform the lossless compression on the input data based on the importance value being greater than or equal to the predetermined threshold.

3. The method of claim 1,
wherein the compression parameter comprises:
a first compression parameter corresponding to the lossy compression or a second compression parameter corresponding to the lossless compression, generated based on the importance value, and
wherein the performing of the lossy compression or the lossless compression comprises:
performing the lossy compression using the first compression parameter; and
performing the lossless compression using the second compression parameter.

4. The method of claim 1,
wherein the compression parameter comprises:
a predetermined third compression parameter corresponding to the lossy compression or a predetermined fourth compression parameter corresponding to the lossless compression parameter,
the lossy compression is performed using the predetermined third compression parameter; and
the lossless compression is performed using the predetermined fourth compression parameter.

5. The method of claim 1, wherein the computing of the importance value comprises:
computing the importance value based on at least one of information on a layer block that outputs the input data or information on the neural network model.

6. The method of claim 1, wherein the computing of an importance value is performed by a first neural network model,
wherein the first neural network model is trained based on data obtained through the neural network model and an importance value corresponding to the data.

7. The method of claim 6, wherein
the performing of the lossy compression is performed by a second neural network model,
the performing of the lossless compression is performed by a third neural network model, and
the second neural network model and the third neural network model are trained using an objective function that reduces a data rate of the input data.

8. The method of claim 7, wherein the neural network model is configured to perform, based on a training result of at least one of the first neural network model, the second neural network model, or the third neural network model, at least one of:
updating a parameter value of the neural network model; or
changing a structure of the neural network model.

9. The method of claim 1, wherein the changing of the structure of the neural network model comprises at least one of:
pruning a layer block of low importance among a plurality of layer blocks of the neural network model; or
changing a channel of the neural network model for the layer block of the low importance,
wherein the layer block of the low importance has a lowest importance among the plurality of layer blocks or has an importance below a predetermined threshold.

10. The method of claim 1, wherein
the neural network model comprises:
a plurality of layer blocks, and
each of at least some of the plurality of layer blocks is configured to:
transfer data that is output from a corresponding layer block to a next layer block, based on predetermined information.

11. The method of claim 1,
wherein the neural network model comprises:
a plurality of layer blocks,
wherein the computing of an importance value comprises:
computing the importance value based on data that is output from a corresponding layer block, among the plurality of layer blocks, and information on the output data, and
wherein the determining of whether to perform the lossy compression or the lossless compression further comprises:
transmitting the output data to a next layer block, among the plurality of layer blocks, based on the importance value of the corresponding layer block.

12. The method of claim 1, wherein the determining of whether to perform the lossy compression or the lossless compression on the input data comprises:
determining whether to perform the lossy compression or the lossless compression based on the importance value and hardware resources.

13. A method for determining a data decompression method in a neural network model, the method comprising:
determining, based on input compressed data and a compression parameter, whether lossy compression or lossless compression has been performed on the input compressed data; and
based on a result of the determination, performing, using the compression parameter, lossy decompression or lossless decompression on the input compressed data to obtain decompressed data.

14. The method of claim 13, wherein
the lossy decompression is performed by a second neural network model,
the lossless decompression is performed by a third neural network model, and
the second neural network model is trained using an objective function that reduces a difference between the decompressed data and original data.

15. A non-transitory computer-readable storage medium storing instructions that, when executed by a processor, cause the processor to perform the method of claim 1.

16. An apparatus for determining a data compression method in a neural network model, the apparatus comprising:
at least one memory configured to store compressed input data and a compression parameter; and
at least one processor configured to execute instructions retrieved from the at least one memory to:
compute an importance value based on input data and information related to the input data;
determine, based on the importance value, whether to perform lossy compression or lossless compression on the input data; and
perform, using the compression parameter, the lossy compression or the lossless compression on the input data, based on a result of the determination.

17. The apparatus of claim 16, wherein the at least one processor is further configured to:
select, based on the importance value, a compression method from among a plurality of compression methods for performing the lossy compression or the lossless compression.

18. The apparatus of claim 17, wherein
the at least one memory comprises at least one main memory and at least one cache memory,
the at least one processor is executed using the at least one cache memory, and
the input data and the compression parameter are stored in the at least one main memory.

19. An apparatus for determining a data decompression method in a neural network model, the apparatus comprising:
at least one memory configured to store compressed data and a compression parameter;
at least one processor configured to execute instructions retrieved from the at least one memory to:
determine, based on the compressed data and the compression parameter, whether lossy compression or lossless compression has been performed on the compressed data; and
perform, using the compression parameter, the lossy decompression or the lossless decompression on the compressed data, based on a result of the determination.

20. The apparatus of claim 19, wherein
the at least one memory comprises at least one main memory and at least one cache memory,
the at least one processor is executed using the at least one cache memory, and
the compressed data and the compression parameter are stored in the at least one main memory.
